(19) United States
(12) Patent Application Publication
(10) Pub. No.: US 2026/0006535 A1
(43) Pub. Date: Jan. 1, 2026

(54) SYNCHRONIZATION SIGNAL BLOCK PATTERN SIGNALING

(71) Applicant: QUALCOMM Incorporated, San Diego, CA (US)

(72) Inventors: Kiran VENUGOPAL, Green Brook, NJ (US); Yan ZHOU, San Diego, CA (US); Tao LUO, San Diego, CA (US); Raghu Narayan CHALLA, San Diego, CA (US); Yongle WU, San Diego, CA (US); Yong LI, San Diego, CA (US); Navid ABEDINI, Basking Ridge, NJ (US)

(21) Appl. No.: 18/761,036

(22) Filed: Jul. 1, 2024

(51) Int. Cl. H04W 48/08; H04W 76/10

(52) U.S. Cl. CPC H04W 48/08; H04W 76/10

(57) ABSTRACT

A method of wireless communication performed by a user equipment (UE) includes: establishing a connection with a primary cell (PCell); receiving, from the PCell, an indication of a synchronization signal block (SSB) configuration associated with a secondary cell (SCell); monitoring, based on the indication, for at least one signal from the SCell based on the indication; and establishing a connection with the SCell based on the at least one signal.

### TECHNICAL FIELD

This application relates to wireless communication systems, and more particularly pattern signaling of synchronization signal blocks (SSBs) for secondary cells (SCells).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum.

BSs may use synchronization signal blocks (SSBs) to establish communication with UEs. SSBs may be transmitted periodically by a BS in a number of channels and/or spatial directions. The overhead of periodic SSB transmissions may be a significant source of power consumption in a network. There is a need in the art for efficient techniques for synchronization signaling while maintaining key performance parameters for user equipment communication.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a user equipment (UE) comprises one or more memories and one or more processors coupled to the one or more memories, the one or more memories storing instructions that are executable by the one or more processors. The processors are configured individually or in any combination, to cause the UE establish a connection with a primary cell (PCell). The processors are further configured to cause the UE to receive, from the PCell, an indication of a synchronization signal block (SSB) configuration associated with a secondary cell (SCell). The processors are further configured to cause the UE to monitor, based on the indication, for at least one signal from the SCell based on the indication. The processors are further configured to cause the UE to establish a connection with the SCell based on the at least one signal.

In an additional aspect of the disclosure, a network unit comprises one or more memories and one or more processors coupled to the one or more memories, the one or more memories storing instructions that are executable by the one or more processors. The processors are configured individually or in any combination, to cause the network unit to establish a connection with a user equipment (UE). The processors are further configured to cause the network unit to transmit, to the UE, an indication of a synchronization signal block (SSB) configuration associated with a secondary cell (SCell), wherein the SSB configuration is based on at least one of a co-location status of the SCell with the network unit, or a subframe number (SFN) alignment status between the network unit and the SCell.

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates a radio frame structure according to some aspects of the present disclosure.

FIG. 4 illustrates an exemplary synchronization signal block, according to some aspects of the present disclosure.

FIG. 5 illustrates an exemplary SSB sequence, according to some aspects of the present disclosure.

FIG. 6 illustrates a signal flow diagram according to some aspects of the present disclosure.

FIG. 7 is a block diagram of an exemplary user equipment (UE) according to some aspects of the present disclosure.

FIG. 8 is a block diagram of an exemplary network unit according to some aspects of the present disclosure.

FIG. 9 is a flow diagram of a communication method according to some aspects of the present disclosure.

FIG. 10 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

A UE may be connected to (or be in the process of connecting to) a primary cell (PCell) and a secondary cell (SCell). Under certain conditions, the UE may not require a full SSB pattern from both the PCell and the SCell. In order to reduce network load and power, the PCell may indicate to the UE information (e.g., an SSB configuration) regarding the SSB pattern of the SCell to the UE. In some aspects, the SSB configuration includes an index value that is associated with a preconfigured SSB pattern. In other aspects the SSB configuration includes a pattern description that is not index-based. The SSB configuration may be determined by PCell 605 based on one or more conditions.

In some aspects, the PCell may indicate an SSB configuration for the SCell that does not include a PSS or SSS based on the SCell being colocated with the PCell. If the SCell is not colocated with the PCell, the SSB configuration may indicate the inclusion of a PSS and/or SSS. In some aspects, if SCell is acting as a PCell for another UE, the SSB configuration may indicate that the SSB pattern includes PBCH signals. In some aspects, if the SCell is not acting as a PCell for another UE, the SSB configuration may indicate that the SSB pattern does not include PBCH. PBCH functions may be replaced by a tracking reference signal (TRS), channel state information reference signal (CSI-RS), or other non-PBCH reference signal.

In some aspects, SCell is a primary SCell (PSCell) and the SSB configuration may depend on whether the PSCell is subframe number (SFN) aligned with the PCell. For example if the PSCell is not SFN aligned with the PCell, the SSB configuration may indicate a full SSB pattern. In some aspects, the SSB configuration may not indicate a PSS and/or SSS based on the PSCell being colocated with the PCell. If the PSCell is SFN aligned with the PCell, the SSB configuration may indicate no SSB (no PSS, no SSS, and no PBCH. In some aspects, the no-SSB SSB configuration may be further based on PCell being colocated with SCell. In some aspects, a non-PBCH reference signal may be configured to perform some of the functions ordinarily performed by an SSB when no SSB is configured. For example, a non-PBCH reference signal may be configured which may include at least one of a tracking reference signal (TRS) or a channel state information reference signal (CSI-RS). In some aspects, if the PSCell is not colocated with the PCell, the SSB configuration may indicate a PSS and/or SSS.

Aspects of the present disclosure may provide several benefits. For example, reduced SSB signaling may be used by an SCell, thereby reducing network load and power consumption. A UE that is indicated the SSB configuration may reduce the complexity of receiving and decoding the SSBs as there may be reduced number of hypotheses for the UE to check, thereby reducing power consumption of the UE as well.

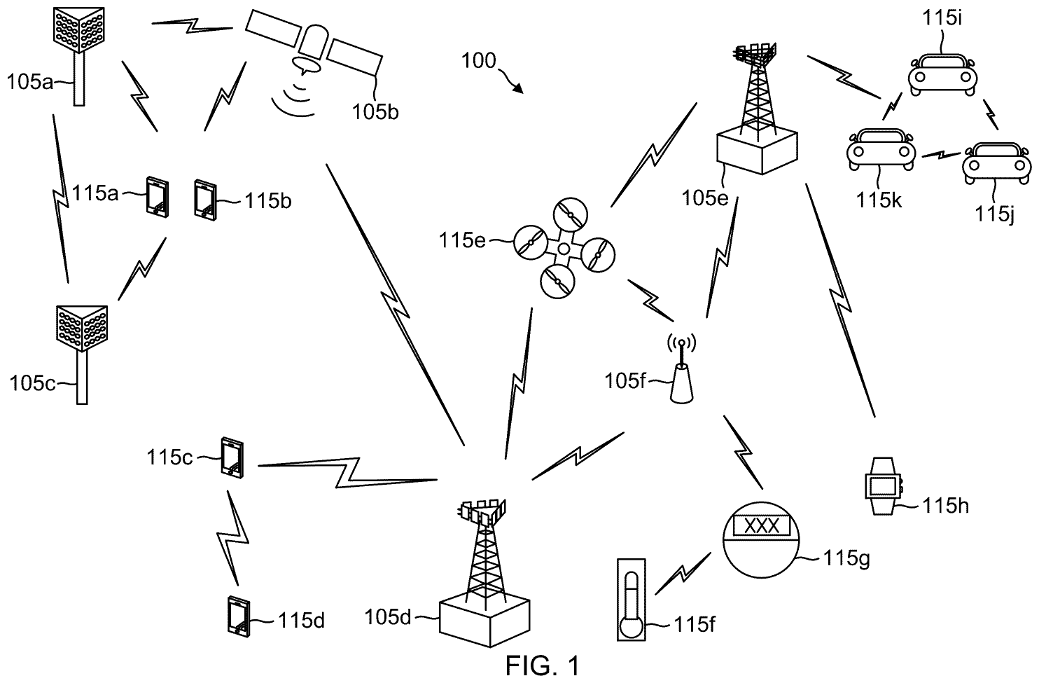

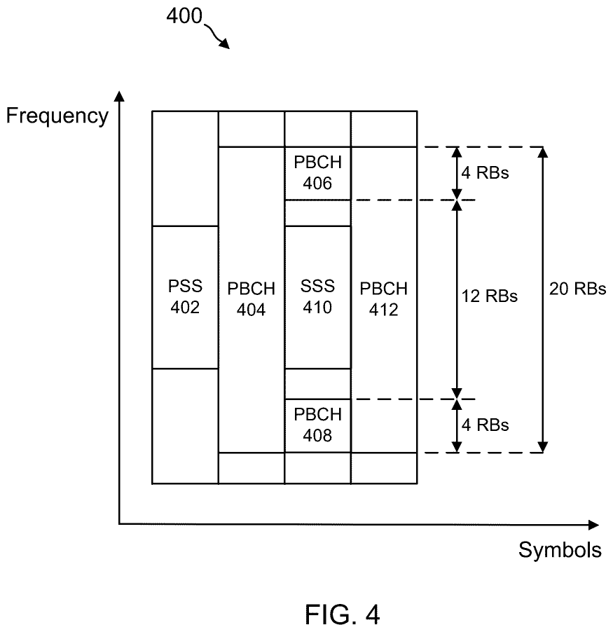

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. The actions of FIGS. 4-6 may be performed by any of UEs 115.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105b, 105d, and 105e may be regular macro BSs, while the BSs 105a and 105c may be macro BSs enabled with one of three dimension (3D), full dimension (FD), or massive MIMO. The BSs 105a and 105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, an Internet of Things (IoT) device, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a and 105c may serve the UEs 115a and 115b using 3D beamforming and coordinated spatial techniques, such as coordinated multipoint (COMP) or multi-connectivity. The macro BS 105d may perform backhaul communications with the BSs 105a and 105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support communications with ultra-reliable and redundant links for devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mmWave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access.

In some aspects, the network 100 may be an IoT network and the UEs 115 may be IoT nodes, such as smart printers, monitors, gaming nodes, cameras, audio-video (AV) production equipment, industrial IoT devices, and/or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band.

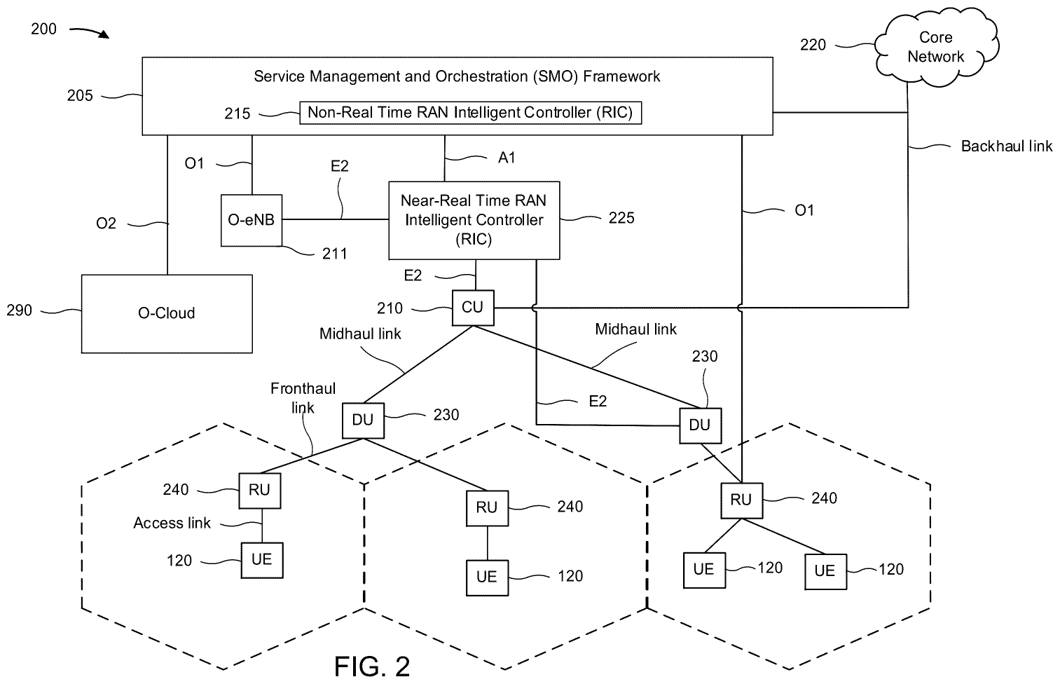

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, a first UE 115 may receive a cross link interference (CLI) measurement resource configuration from the RU 240, DU 230, and/or CU 210. In some aspects, the CLI measurement resource configuration may indicate a plurality of CLI measurement occasions. The first UE 115 may measure CLI associated with a second UE 115 in the plurality of CLI measurement occasions and transmit one or more CLI measurement reports associated with the measured CLI to the RU 240, DU 230, and/or CU 210.

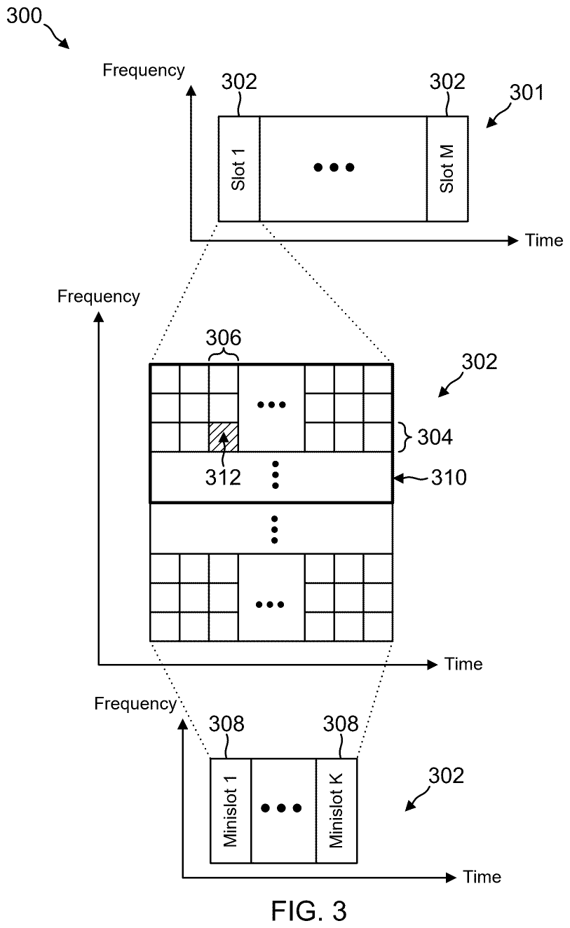

FIG. 3 is a timing diagram illustrating a radio frame structure 300 according to some aspects of the present disclosure. The radio frame structure 300 may be employed by BSs such as the BSs 105 and UEs such as the UEs 115 in a network such as the network 100 for communications. In particular, the BS may communicate with the UE using time-frequency resources configured as shown in the radio frame structure 300. In FIG. 3, the x-axes represent time in some arbitrary units and the y-axes represent frequency in some arbitrary units. The transmission frame structure 300 includes a radio frame 301. The duration of the radio frame 301 may vary depending on the aspects. In an example, the radio frame 301 may have a duration of about ten milliseconds. The radio frame 301 includes M number of slots 302, where M may be any suitable positive integer. In an example, M may be about 10.

Each slot 302 includes a number of subcarriers 304 in frequency and a number of symbols 306 in time. The number of subcarriers 304 and/or the number of symbols 306 in a slot 302 may vary depending on the aspects, for example, based on the channel bandwidth, the subcarrier spacing (SCS), and/or the cellular processor (CP) mode. One subcarrier 304 in frequency and one symbol 306 in time forms one resource element (RE) 312 for transmission. A resource block (RB) 310 is formed from a number of consecutive subcarriers 304 in frequency and a number of consecutive symbols 306 in time.

In an example, a network unit (e.g., BS 105 in FIG. 1, CU 210, or DU 230 in FIG. 2) may schedule a UE (e.g., UE 115 in FIG. 1) for UL and/or DL communications at a time-granularity of slots 302 or mini-slots 308. Each slot 302 may be time-partitioned into K number of mini-slots 308. Each mini-slot 308 may include one or more symbols 306. The mini-slots 308 in a slot 302 may have variable lengths. For example, when a slot 302 includes N number of symbols 306, a mini-slot 308 may have a length between one symbol 306 and (N−1) symbols 306. In some aspects, a mini-slot 308 may have a length of about two symbols 306, about four symbols 306, or about seven symbols 306. In some examples, the BS may schedule UE at a frequency-granularity of a resource block (RB) 310 (e.g., including about 12 subcarriers 304).

FIG. 4 illustrates an exemplary synchronization signal block 400, according to some aspects of the present disclosure. A BS 105 (or other network entity) can transmit a SSB 400 which may include synchronization signals (e.g., including a primary synchronization signal (PSS) 402 and/or a secondary synchronization signal (SSS) 410) in a network (e.g., network) 100. SSB 400 may further include one or more PBCH messages, which may include a demodulation reference signal (DMRS) or data. In some aspects, SSB 400 includes a PSS 402 in a first symbol, over a first set of frequencies. The remaining three symbols may include for PBCH 404, PBCH 406, PBCH 408, PBCH 412, and SSS 410. PBCH 404 may span a larger set of frequencies than PSS 402 and SSS 410. For example, PBCH 404 and PBCH 412 may use 20 RBs. SSS 410 may be frequency division multiplexed with PBCH 406 and PBCH 408.

In some aspects, SSB 400 may be transmitted (e.g., by a BS 105) in bursts including multiple SSBs 400. Each SSB of an SSB burst may have an associated ID. Each SSB of an SSB burst may be transmitted in a different spatial direction (i.e., via a different beam). By receiving an SSB 400, a UE 115 may determine an optimal/preferred direction for receiving and/or transmitting signals, for example by determining the receives SSB 400 with the highest received power.

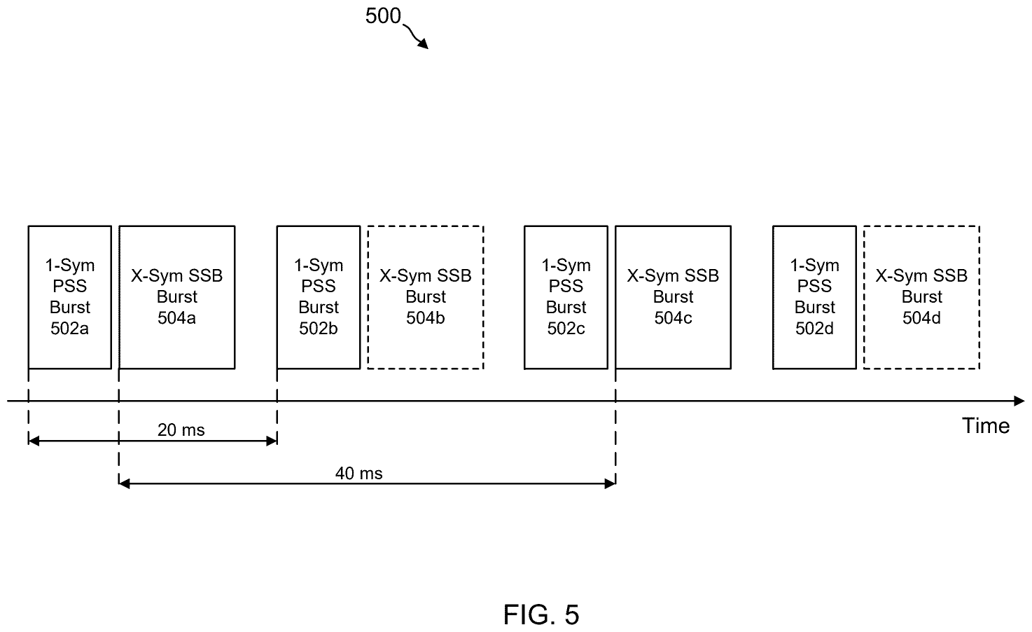

FIG. 5 illustrates an exemplary SSB sequence 500, according to some aspects of the present disclosure. As illustrated, a network entity (e.g., a BS 105) may transmit a 1 symbol PSS burst 502a. The 1 symbol PSS burst 502a may include multiple PSS transmissions, each one symbol in length. In some aspects, each PSS of PSS burst 502a is transmitted with a different transmission parameter (e.g., in a different spatial direction associated with a certain beam). As illustrated, the PSS burst 502a may be followed by an X-symbol SSB burst 504a. In some aspects, each SSB of SSB burst 504a is a 2, 3, or 4 symbol SSB 400. A 2 symbol SSB may include only PBCH symbols. A 3 symbol SSB may include PBCH symbols and an SSS symbol that may be frequency division multiplexed with PBCH as illustrated in FIG. 4. A 4 symbol SSB may be an SSB the includes PSS, SSS, and PBCH as illustrated in FIG. 4.

In some aspects, each PSS of PSS burst 502a is associated with a respective SSB of SSB burst 504a. This pattern may repeat, for example ever 20 ms, with a PSS burst 502 followed by an associated SSB burst 504. FIG. 5 illustrates a few exemplary repetitions including PSS burst 502b with SSB burst 504b, PSS burst 502c with SSB burst 504c, and PSS burst 502d with SSB burst 504d.

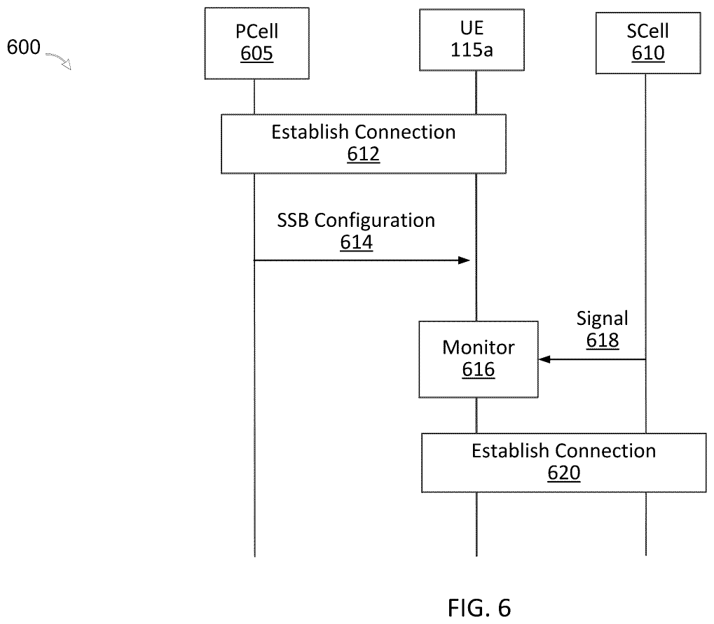

To reduce energy consumption, the transmitting entity may transmit less frequent SSB bursts 502. In the illustrated example, SSB bursts 504b and 504d are not transmitted (as indicated by the dashed lines) so that the SSB bursts 504 are effectively transmitted at 40 ms intervals. PSS bursts 402 may still be transmitted at the more frequency periodicity (e.g., 20 ms) so that UEs may maintain synchronization even with less frequent SSB bursts 504. Other patterns may be configured, for example SSB bursts 504 every 80 ms with PSS bursts 502 every 20 ms. Less frequent SSB bursts 504 results in lower energy consumption but may lead to higher initial access latency. The presence of the more frequent PSS bursts 502 maintains the same cell presence detection latency. In some aspects, the PSS bursts 502 may be used for cell presence detection and the associated SSB bursts 504 may be used for cell identification. In some aspects, the presence of PSS burst 502 allows for SSB bursts 504 to not include a separate PSS (i.e., a 3 symbol SSB). In other aspects, SSB bursts 504 also include a PSS (i.e., a 4 symbol SSB), meaning that the PSS bursts 502 are transmitted in addition to the SSB PSSs. In the case of a 4 symbol SSB, the inclusion of a separate PSS burst means that when SSBs are transmitted at the same periodicity as the PSS bursts, then the total transmissions are higher than if the network were to only transmit the 4 symbol SSB bursts without the PSS burst. Certain conditions may require the use of the PSS within the SSB (i.e., a 4 symbol SSB), while other conditions may allow for 3 or 2 symbol SSBs. To accommodate for using the SSB pattern needed while reducing network power, additional signaling may be provided, as described with respect to FIG. 6.

FIG. 6 illustrates a signal flow diagram 600 according to some aspects of the present disclosure. Actions of the communication method 600 can be executed by a computing device (e.g., a processor, processing circuit, and/or other suitable component) of a communication device or other suitable means for performing the actions. As illustrated, signal flow diagram includes a PCell 605, UE 115a, and SCell 610. UE 115s may be a UE 115 or UE 700, and may utilize one or more components, such as the processor 702, the memory 704, the SSB module 708, the transceiver 710, the modem 712, and the one or more antennas 716, to execute aspects of method 600. PCell 605 and SCell 610 may be network unit 105s or 800, and may utilize one or more respective components, such as the processor 802, the memory 804, the SSB module 808, the transceiver 810, the modem 812, and the one or more antennas 816, to execute aspects of method 600. For example, PCell 605 may be a BS 105, CU210, DU 230, or network unit 800. PCell 605 may act as a PCell for certain UEs while acting as a SCell for other UEs. Similarly, SCell 610 may be a BS 105, CU210, DU 230, or network unit 800. SCell 610 may act as a SCell for certain UEs while acting as a PCell for other UEs. SCell 610 may be a primary SCell (PSCell).

At action 612, PCell 605 establishes a connection with UE 115a. This connection may establish the relationship between PCell 605 and UE 115a that identifies PCell 605 as a primary cell with respect to UE 115a.

At action 614, PCell 605 may transmit an SSB configuration to UE 115a. The SSB configuration may include information regarding SSB format and patterns related to SCell 610. In some aspects, the SSB configuration includes an index value that is associated with a preconfigured SSB pattern. In some aspects, the SSB configuration includes a pattern description that is not based on indexing a preconfigured pattern. SSB patterns indicated may include reference signals and/or channels and corresponding time and frequencies within the SSB, and time and frequencies of the SSB itself. The SSB configuration may be determined by PCell 605 based on one or more conditions.

In some aspects, when SCell 610 is colocated with PCell 605, the SSB configuration may indicate that the SSB pattern for SCell 610 may not include a PSS and/or SSS since timing information (e.g., an accurate frame boundary) may be reliably derived from signals received from PCell 605. In some aspects, when SCell 610 is not colocated with PCell 605, the SSB configuration may indicate an SSB pattern that includes an SSS and/or PSS as necessary. In some aspects, if SCell 610 is acting as a PCell for another UE 115, the SSB configuration may indicate that the SSB pattern of SCell 610 includes PBCH signals as they may be necessary to transmit for UEs for which SCell 610 is a PCell. In some aspects, the SSB requirements for an SCell 610 acting as a PCell may differ, and the SSB configuration may indicate the appropriate SSB pattern suitable for a PCell. In some aspects, if SCell 610 is not acting as a PCell for another UE, the SSB configuration may indicate that the SSB pattern for SCell 610 does not include PBCH. PBCH functions may be replaced by a tracking reference signal (TRS), channel state information reference signal (CSI-RS), or other non-PBCH reference signal.

In some aspects, SCell 610 is a primary SCell (PSCell). If SCell 610 is a PSCell but is serving as a PCell for another UE, the SSB configuration may indicate an SSB pattern that is suitable for a PCell (e.g., including a PSS, SSS, and PBCH). If SCell 610 is a PSCell and is not serving as a PCell for another UE 115, the SSB configuration may depend on whether SCell 610 is subframe number (SFN) aligned with PCell 605. For example if SCell 610 is a PSCell and is not SFN aligned with PCell 605, the SSB configuration may indicate an SSB pattern with PBCH, PSS, and SSS (e.g., a 4 symbol SSB). In some aspects, the SSB configuration may not indicate a PSS and/or SSS based on SCell 610 being colocated with PCell 605. If SCell 610 is a PSCell and is SFN aligned with PCell 605, the SSB configuration may indicate no SSB (no PSS, no SSS, and no PBCH) as the function of SCell 610 SSB may be fulfilled by SSBs from PCell 605. In some aspects, the no-SSB SSB configuration may be further based on PCell 605 being colocated with SCell 610. In some aspects, a non-PBCH reference signal may be configured to perform some of the functions ordinarily performed by an SSB when no SSB is configured. For example, a non-PBCH reference signal may be configured which may include at least one of a tracking reference signal (TRS) or a channel state information reference signal (CSI-RS). In some aspects, if SCell 610 is a PSCell and is not colocated with PCell 605, the SSB configuration may indicate a PSS and/or SSS. The PSS and SSS of SCell 610 may be used by UE 115a for timing and frequency errors based on not being colocated with PCell 605.

At action 616, UE 115a monitors for signals 618 from SCell 610 based on the SSB configuration received at action 614. For example, UE 115a may monitor and receive a SSB that is a 2 symbol, 3 symbol, or 4 symbol SSB according to the SSB configuration. In some aspects, a non-PBCH reference signal is received rather than an SSB, according to the SSB configuration. For example, a non-PBCH reference signal may include at least one of a tracking reference signal (TRS) or a channel state information reference signal (CSI-RS).

At action 620, UE 115a and SCell 610 establish a connection based on the received signals 618. In some aspects, UE 115a is already connected to SCell 610, and the SSB configuration received at action 614 is for an active connected SSB pattern for reception by UE 115a from SCell 610.

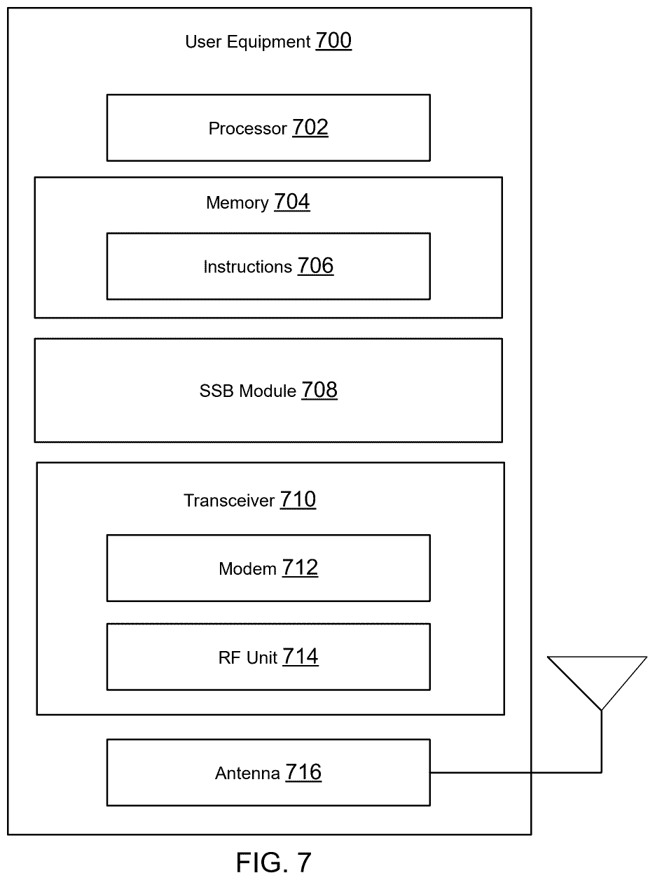

FIG. 7 is a block diagram of an exemplary UE 700 according to some aspects of the present disclosure. The UE 700 may be the UE 115 in the network 100 or 200 as discussed above. As shown, the UE 700 may include a processor 702, a memory 704, a SSB module 708, a transceiver 710 including a modem subsystem 712 and a radio frequency (RF) unit 714, and one or more antennas 716. These elements may be coupled with each other and in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 704 includes a non-transitory computer-readable medium. The memory 704 may store instructions 706. The instructions 706 may include instructions that, when executed by the processor 702, cause the processor 702 to perform the operations described herein with reference to the UEs 115 in connection with aspects of the present disclosure, for example, aspects of FIGS. 4-6. Instructions 706 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SSB module 708 may be implemented via hardware, software, or combinations thereof. For example, the SSB module 708 may be implemented as a processor, circuit, and/or instructions 706 stored in the memory 704 and executed by the processor 702. In some aspects, the SSB module 708 may implement the aspects of FIGS. 4-6. For example, the SSB module 708 of a first UE (e.g., the UE 115 or 700) may establish a connection with a primary cell (PCell). SSB module 708 may further receive, from the PCell, an indication of a synchronization signal block (SSB) configuration associated with a secondary cell (SCell). The SSB module 708 may further monitor, based on the indication, for at least one signal from the SCell based on the indication. The SSB module 708 may further establish a connection with the SCell based on the at least one signal.

As shown, the transceiver 710 may include the modem subsystem 712 and the RF unit 714. The transceiver 710 can be configured to communicate bi-directionally with other devices, such as the BSs 105 and/or the UEs 115. The modem subsystem 712 may be configured to modulate and/or encode the data from the memory 704 and the according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The antennas 716 may include multiple antennas of similar or different designs in order to sustain multiple transmission links. The RF unit 714 may configure the antennas 716.

In some instances, the UE 700 can include multiple transceivers 710 implementing different RATs (e.g., NR and LTE). In some instances, the UE 700 can include a single transceiver 710 implementing multiple RATs (e.g., NR and LTE). In some instances, the transceiver 710 can include various components, where different combinations of components can implement RATs.

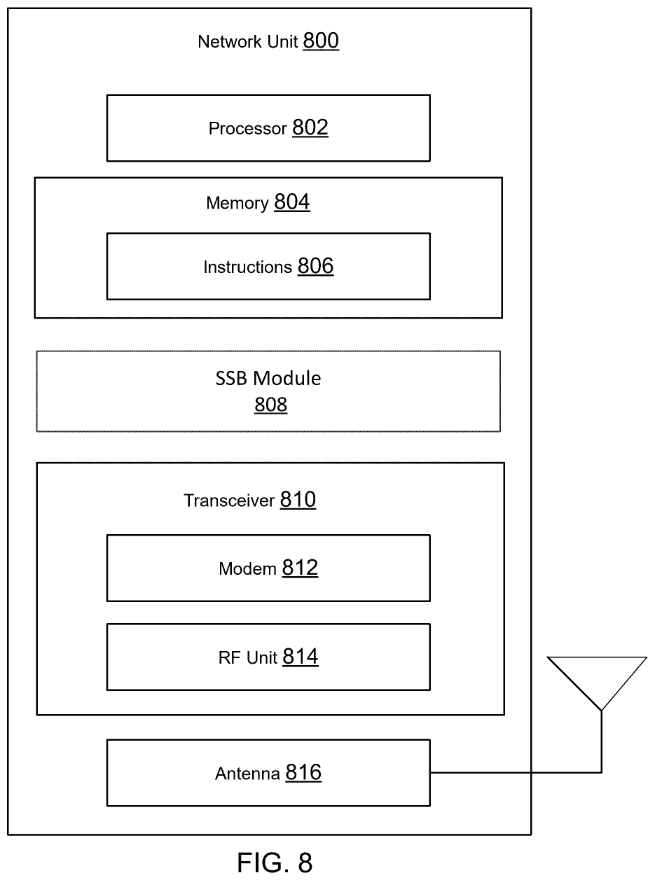

FIG. 8 is a block diagram of an exemplary network unit 800 according to some aspects of the present disclosure. The network unit 800 may be the BS 105, the CU 210, the DU 230, or the RU 240, as discussed above. As shown, the network unit 800 may include a processor 802, a memory 804, a SSB module 808, a transceiver 810 including a modem subsystem 812 and a RF unit 814, and one or more antennas 816. These elements may be coupled with each other and in direct or indirect communication with each other, for example via one or more buses.

The processor 802 may have various features as a specific-type processor. For example, these may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 804 may include a non-transitory computer-readable medium. The memory 804 may store instructions 806. The instructions 806 may include instructions that, when executed by the processor 802, cause the processor 802 to perform operations described herein, for example, aspects of FIGS. 4-6. Instructions 806 may also be referred to as code, which may be interpreted broadly to include any type of computer-readable statement(s).

The SSB module 808 may be implemented via hardware, software, or combinations thereof. For example, the SSB module 808 may be implemented as a processor, circuit, and/or instructions 806 stored in the memory 804 and executed by the processor 802.

In some aspects, the SSB module 808 may implement the aspects of FIGS. 4-6. For example, the SSB module 808 may establish a connection with a user equipment (UE). SSB module 808 may further transmit, to the UE, an indication of a synchronization signal block (SSB) configuration associated with a secondary cell (SCell), wherein the SSB configuration is based on at least one of: a co-location status of the SCell with the network unit, or a subframe number (SFN) alignment status between the network unit and the SCell.

As shown, the transceiver 810 may include the modem subsystem 812 and the RF unit 814. The transceiver 810 can be configured to communicate bi-directionally with other devices, such as the UEs 115 and/or 600. The modem subsystem 812 may be configured to modulate and/or encode data according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or UE 600. The RF unit 814 may be further configured to perform analog beamforming in conjunction with the digital beamforming. Although shown as integrated together in transceiver 810, the modem subsystem 812 and/or the RF unit 814 may be separate devices that are coupled together at the network unit 800 to enable the network unit 800 to communicate with other devices.

The RF unit 814 may provide the modulated and/or processed data, e.g. data packets (or, more generally, data messages that may contain one or more data packets and other information), to the antennas 816 for transmission to one or more other devices. This may include, for example, a configuration indicating a plurality of sub-slots within a slot according to aspects of the present disclosure. The antennas 816 may further receive data messages transmitted from other devices and provide the received data messages for processing and/or demodulation at the transceiver 810. The antennas 816 may include multiple antennas of similar or different designs in order to sustain multiple transmission links.

In some instances, the network unit 800 can include multiple transceivers 810 implementing different RATs (e.g., NR and LTE). In some instances, the network unit 800 can include a single transceiver 810 implementing multiple RATs (e.g., NR and LTE). In some instances, the transceiver 810 can include various components, where different combinations of components can implement RATs.

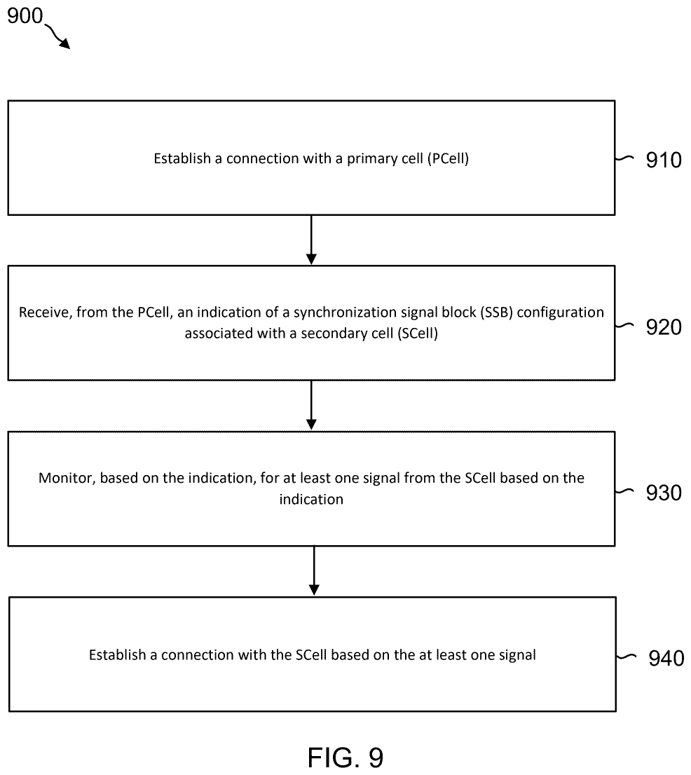

FIG. 9 is a flow diagram of a communication method 900 according to some aspects of the present disclosure. Actions of the method 900 can be executed by a computing device (e.g., a processor, processing circuit, and/or other suitable component) of an apparatus or other suitable means for performing the steps. For example, a UE, such as the UEs 115 and/or the UE 700, may utilize one or more components, such as the processor 702, the memory 704, the SSB module 708, the transceiver 710, and the one or more antennas 716, to execute the steps of method 900. For instance, the method may be performed by an application processor, a modem chipset, and SOC hosting an application processor and modem chipset, or the like.

As illustrated, the method 900 includes a number of enumerated actions, but aspects of the method 900 may include additional steps before, after, and in between the enumerated actions. In some aspects, one or more of the enumerated actions may be omitted or performed in a different order.

At block 910, a UE establishes a connection with a PCell.

At block 920, the UE receives, from the PCell, an indication of a synchronization signal block (SSB) configuration associated with a secondary cell (SCell). The SCell may or may not be colocated with the PCell. The SCell may be a primary SCell (PSCell). In some aspects, the indication includes an index value associated with the SSB configuration. The SSB configuration may, for example, be one of a plurality of preconfigured SSB configurations. For example, the UE may store a table in memory where the table includes indexes and an associated SSB configuration associated with each index. In this way, the indication may be a relatively small value while indicating details about an SSB configuration. In some aspects, the index value may be associated with a “scenario” and the scenario may be mapped to a SSB configuration. A scenario description may be based on the colocation and/or SFN alignment status. In some aspects, the UE may receive a scenario id/pattern id (which is mapped to a default SSB configuration) together with a delta value to adjust the default setting. For example, the delta value may indicate an amount to increase or decrease the period of PBCH/SSS/x-sym SSB/non-PBCH signal etc. or to indicate the inclusion or exclusion of the PSS, SSS, or PBCH.

At block 930, the UE monitors, based on the indication, for at least one signal from the SCell based on the indication. In some aspects, the SSB configuration identifies a PSS and a SSS with no associated PBCH message, and the at least one signal includes the PSS and the SSS. In some aspects, the at least one signal further includes a non-PBCH reference signal. In some aspects, the non-PBCH reference signal may include at least one of a tracking reference signal (TRS) or a channel state information reference signal (CSI-RS). In some aspects, the non-PBCH reference signal may be used by the UE to perform beam management, time tracking, and/or frequency tracking.

At block 940, the UE establishes a connection with the SCell based on the at least one signal. The UE may establish the connection with the SCell further based on a frame boundary based on a signal from the PCell.

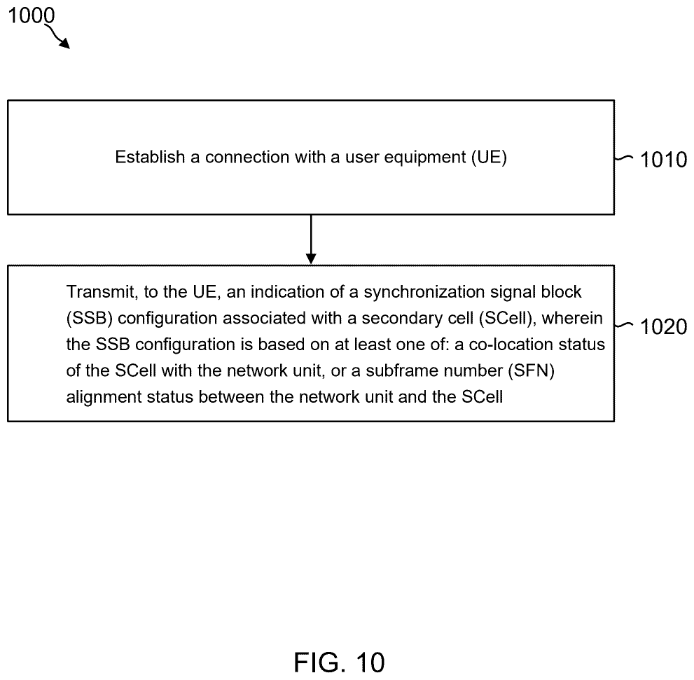

FIG. 10 is a flow diagram of a communication method 1000 according to some aspects of the present disclosure. Actions of the method 300 can be executed by a computing device (e.g., a processor, processing circuit, and/or other suitable component) of an apparatus or other suitable means for performing the steps. For example, a network unit, such as the BSs 105, CU 210, DU 230, and/or the network unit 800, may utilize one or more components, such as the processor 802, the memory 804, the SSB module 808, the transceiver 810, and the one or more antennas 816, to execute the steps of method 1000. For instance, the method may be performed by an application processor, a modem chipset, and SOC hosting an application processor and modem chipset, or the like.

As illustrated, the method 1000 includes a number of enumerated actions, but aspects of the method 1000 may include additional steps before, after, and in between the enumerated actions. In some aspects, one or more of the enumerated actions may be omitted or performed in a different order.

At block 1010, a network unit establishes a connection with a UE (e.g., a UE 115 or UE 700).

At block 1020, the network unit transmits, to the UE, an indication of a synchronization signal block (SSB) configuration associated with a secondary cell (SCell), wherein the SSB configuration is based on at least one of: a co-location status of the SCell with the network unit, or a subframe number (SFN) alignment status between the network unit and the SCell. In some aspects, the network unit an SCell have a SFN alignment, and the SSB configuration indicates no PBCH is transmitted by the SCell associated with an SSB. In some aspects, the network unit is colocated with the SCell. In some aspects, the SSB configuration indicates no PSS and no SSS are transmitted by the SCell. In some aspects, the network unit is not colocated with the SCell, and the SSB configuration indicates a PSS and a SSS are transmitted by the SCell.

In some aspects, the network unit and SCell do not have a SFN alignment, and the SSB configuration indicates a PBCH is transmitted by the SCell associated with an SSN. The SSB configuration may indicate a PSS signal and a SSS signal are transmitted by the SCell. In some aspects, the SSB configuration indicates the SCell will not transmit a PBCH signal associated with a SSB, and the SCell will transmit a non-PBCH reference signal. The non-PBCH reference signal may include one of a tracking reference signal (TRS), or a CSI-RS. In some aspects, the SCell is a PCell for one or more other UEs. The SSB configuration may indicate a PSS, a SSS, and a PBCH signal are transmitted by the SCell associated with an SSB. In some aspects, the SCell is a primary SCell (PSCell). In some aspects, the SSB configuration may indicate a PSS, a SSS, and a PCBH signal are transmitted by the SCell associated with an SSB. In some aspects, the indication includes an index value associated with the SSB configuration, and the SSB configuration is one of a plurality of preconfigured SSB configurations. For example, the UE may store a table in memory where the table includes indexes and an associated SSB configuration associated with each index. In this way, the indication may be a relatively small value while indicating details about an SSB configuration. In some aspects, the index value may be associated with a “scenario” and the scenario may be mapped to a SSB configuration. A scenario description may be based on the colocation and/or SFN alignment status. In some aspects, the network unit may transmit a scenario id/pattern id (which is mapped to a default SSB configuration) together with a delta value to adjust the default setting. For example, the delta value may indicate an amount to increase or decrease the period of PBCH/SSS/x-sym SSB/non-PBCH signal etc. or to indicate the inclusion or exclusion of the PSS, SSS, or PBCH.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

Various embodiments are further described with respect to the enumerated aspects below:

Aspect 1. A user equipment (UE), comprising:
one or more memories; and
one or more processors coupled to the one or more memories, the one or more memories storing instructions that are executable by the one or more processors, configured individually or in any combination, to cause the UE to:
   establish a connection with a primary cell (PCell);
   receive, from the PCell, an indication of a synchronization signal block (SSB) configuration associated with a secondary cell (SCell);
   monitor, based on the indication, for at least one signal from the SCell based on the indication; and
   establish a connection with the SCell based on the at least one signal.

Aspect 2. The UE of aspect 1, wherein:
the SCell is not colocated with the PCell,
the SSB configuration identifies a primary synchronization signal (PSS) and a secondary synchronization signal (SSS) with no associated physical broadcast channel (PBCH) message, and
the at least one signal includes the PSS and the SSS.

Aspect 3. The UE of aspect 1, wherein:
the SCell is colocated with the PCell, and
the at least one signal includes at least one of a tracking reference signal (TRS) or a channel state information reference signal (CSI-RS).

Aspect 4. The UE of any of aspects 1-3, wherein the one or more memories further store instructions that are executable by the one or more processors, configured individually or in any combination, to cause the UE to:
establish the connection with the SCell further based on a frame boundary based on a signal from the PCell.

Aspect 5. The UE of any of aspects 1-4, wherein the at least one signal further includes a non-PBCH reference signal.

Aspect 6. The UE of aspect 5, wherein the non-PBCH reference signal is at least one of a tracking reference signal (TRS) or a channel state information reference signal (CSI-RS).

Aspect 7. The UE of aspect 6, wherein the one or more memories further store instructions that are executable by the one or more processors, configured individually or in any combination, to cause the UE to:
based on the non-PBCH reference signal, perform at least one of:
   beam management;
   time tracking; or
   frequency tracking.

Aspect 8. The UE of any of aspects 1-7, wherein the SCell is a primary SCell (PSCell).

Aspect 9. The UE of any of aspects 1-8, wherein:
the indication includes an index value associated with the SSB configuration, and
the SSB configuration is one of a plurality of preconfigured SSB configurations.

Aspect 10. A network unit, comprising:
one or more memories; and
one or more processors coupled to the one or more memories, the one or more memories storing instructions that are executable by the one or more processors, configured individually or in any combination, to cause the network unit to:
   establish a connection with a user equipment (UE); and
   transmit, to the UE, an indication of a synchronization signal block (SSB) configuration associated with a secondary cell (SCell), wherein the SSB configuration is based on at least one of:
      a co-location status of the SCell with the network unit, or
      a subframe number (SFN) alignment status between the network unit and the SCell.

Aspect 11. The network unit of aspect 10, wherein:
the network unit and SCell have a subframe number (SFN) alignment, and
the SSB configuration indicates no physical broadcast channel (PBCH) is transmitted by the SCell associated with an SSB.

Aspect 12. The network unit of aspect 11, wherein:
the network unit is colocated with the SCell, and
the SSB configuration indicates no primary synchronization signal (PSS) and no secondary synchronization signal (SSS) are transmitted by the SCell.

Aspect 13. The network unit of aspect 11, wherein:
the network unit is not colocated with the SCell, and
the SSB configuration indicates a primary synchronization signal (PSS) and a secondary synchronization signal (SSS) are transmitted by the SCell.

Aspect 14. The network unit of aspect 10, wherein:
the network unit and SCell do not have a subframe number (SFN) alignment, and
the SSB configuration indicates a physical broadcast channel (PBCH) is transmitted by the SCell associated with an SSB.

Aspect 15. The network unit of aspect 14, wherein:
the SSB configuration indicates a primary synchronization signal (PSS) and a secondary synchronization signal (SSS) are transmitted by the SCell, and
the network unit is not colocated with the SCell.

Aspect 16. The network unit of aspect 10, wherein the SSB configuration indicates the SCell will not transmit a PBCH signal associated with a SSB, and the SCell will transmit a non-PBCH reference signal, wherein the non-PBCH reference signal includes at least one of a tracking reference signal (TRS) or a channel state information reference signal (CSI-RS).

Aspect 17. The network unit of aspect 10, wherein:
the SCell is a PCell for one or more other UEs, and
the SSB configuration indicates a primary synchronization signal (PSS), a secondary synchronization signal (SSS), and a physical broadcast channel (PBCH) signal are transmitted by the SCell associated with an SSB.

Aspect 18. The network unit of any of aspects 10-17, wherein the SCell is a primary SCell (PSCell).

Aspect 19. The network unit of aspect 18, wherein:
the SCell is a PCell for one or more other UEs, and
the SSB configuration indicates a primary synchronization signal (PSS), a secondary synchronization signal (SSS), and a physical broadcast channel (PBCH) signal are transmitted by the SCell associated with an SSB.

Aspect 20. The network unit of any of aspects 10-19, wherein:
the indication includes an index value associated with the SSB configuration, and
the SSB configuration is one of a plurality of preconfigured SSB configurations.

Aspect 21. A method of wireless communication performed by a user equipment (UE), comprising:
establishing a connection with a primary cell (PCell);
receiving, from the PCell, an indication of a synchronization signal block (SSB) configuration associated with a secondary cell (SCell);
monitoring, based on the indication, for at least one signal from the SCell based on the indication; and
establishing a connection with the SCell based on the at least one signal.

Aspect 22. A method of wireless communication performed by a network unit, comprising:
establishing a connection with a user equipment (UE); and
transmitting, to the UE, an indication of a synchronization signal block (SSB) configuration associated with a secondary cell (SCell), wherein the SSB configuration is based on at least one of:
   a co-location status of the SCell with the network unit, or
   a subframe number (SFN) alignment status between the network unit and the SCell.

What is claimed is:

1. A user equipment (UE), comprising:
one or more memories; and
one or more processors coupled to the one or more memories, the one or more memories storing instructions that are executable by the one or more processors, configured individually or in any combination, to cause the UE to:
establish a connection with a primary cell (PCell);
receive, from the PCell, an indication of a synchronization signal block (SSB) configuration associated with a secondary cell (SCell);
monitor, based on the indication, for at least one signal from the SCell based on the indication; and
establish a connection with the SCell based on the at least one signal.

2. The UE of claim 1, wherein:
the SCell is not colocated with the PCell,
the SSB configuration identifies a primary synchronization signal (PSS) and a secondary synchronization signal (SSS) with no associated physical broadcast channel (PBCH) message, and
the at least one signal includes the PSS and the SSS.

3. The UE of claim 1, wherein:
the SCell is colocated with the PCell, and
the at least one signal includes at least one of a tracking reference signal (TRS) or a channel state information reference signal (CSI-RS).

4. The UE of claim 1, wherein the one or more memories further store instructions that are executable by the one or more processors, configured individually or in any combination, to cause the UE to:
establish the connection with the SCell further based on a frame boundary based on a signal from the PCell.

5. The UE of claim 1, wherein the at least one signal further includes a non-PBCH reference signal.

6. The UE of claim 5, wherein the non-PBCH reference signal is at least one of a tracking reference signal (TRS) or a channel state information reference signal (CSI-RS).

7. The UE of claim 6, wherein the one or more memories further store instructions that are executable by the one or more processors, configured individually or in any combination, to cause the UE to:
based on the non-PBCH reference signal, perform at least one of:
beam management;
time tracking; or
frequency tracking.

8. The UE of claim 1, wherein the SCell is a primary SCell (PSCell).

9. The UE of claim 1, wherein:
the indication includes an index value associated with the SSB configuration, and
the SSB configuration is one of a plurality of preconfigured SSB configurations.

10. A network unit, comprising:
one or more memories; and
one or more processors coupled to the one or more memories, the one or more memories storing instructions that are executable by the one or more processors, configured individually or in any combination, to cause the network unit to:
establish a connection with a user equipment (UE); and
transmit, to the UE, an indication of a synchronization signal block (SSB) configuration associated with a secondary cell (SCell), wherein the SSB configuration is based on at least one of:
a co-location status of the SCell with the network unit, or
a subframe number (SFN) alignment status between the network unit and the SCell.

11. The network unit of claim 10, wherein:
the network unit and SCell have a subframe number (SFN) alignment, and
the SSB configuration indicates no physical broadcast channel (PBCH) is transmitted by the SCell associated with an SSB.

12. The network unit of claim 11, wherein:
the network unit is colocated with the SCell, and
the SSB configuration indicates no primary synchronization signal (PSS) and no secondary synchronization signal (SSS) are transmitted by the SCell.

13. The network unit of claim 11, wherein:
the network unit is not colocated with the SCell, and
the SSB configuration indicates a primary synchronization signal (PSS) and a secondary synchronization signal (SSS) are transmitted by the SCell.

14. The network unit of claim 10, wherein:
the network unit and SCell do not have a subframe number (SFN) alignment, and
the SSB configuration indicates a physical broadcast channel (PBCH) is transmitted by the SCell associated with an SSB.

15. The network unit of claim 14, wherein:
the SSB configuration indicates a primary synchronization signal (PSS) and a secondary synchronization signal (SSS) are transmitted by the SCell, and
the network unit is not colocated with the SCell.

16. The network unit of claim 10, wherein the SSB configuration indicates the SCell will not transmit a PBCH signal associated with a SSB, and the SCell will transmit a non-PBCH reference signal, wherein the non-PBCH reference signal includes at least one of a tracking reference signal (TRS) or a channel state information reference signal (CSI-RS).

17. The network unit of claim 10, wherein:
the SCell is a PCell for one or more other UEs, and
the SSB configuration indicates a primary synchronization signal (PSS), a secondary synchronization signal (SSS), and a physical broadcast channel (PBCH) signal are transmitted by the SCell associated with an SSB.

18. The network unit of claim 10, wherein the SCell is a primary SCell (PSCell).

19. The network unit of claim 18, wherein:
the SCell is a PCell for one or more other UEs, and
the SSB configuration indicates a primary synchronization signal (PSS), a secondary synchronization signal (SSS), and a physical broadcast channel (PBCH) signal are transmitted by the SCell associated with an SSB.

20. The network unit of claim 10, wherein:
the indication includes an index value associated with the SSB configuration, and
the SSB configuration is one of a plurality of preconfigured SSB configurations.
